(19) United States
(12) Patent Application Publication
(10) Pub. No.: US 2020/0378649 A1
(43) Pub. Date: Dec. 3, 2020

(54) HOT-WATER MAT AND STERILIZATION MODULE

(71) Applicant: KYUNGDONG NAVIEN CO., LTD., Gyeonggi-do (KR)

(72) Inventors: Soo Young LEE, Seoul (KR); Gu Min LIM, Seoul (KR); Im Suk CHOI, Seoul (KR); Ki Chul CHO, Seoul (KR)

(73) Assignee: KYUNGDONG NAVIEN CO., LTD., Gyeonggi-do (KR)

(21) Appl. No.: 16/767,087

(22) PCT Filed: Dec. 28, 2018
(86) PCT No.: PCT/KR2018/016879

§ 371 Date: May 26, 2020

(30) Foreign Application Priority Data
Dec. 28, 2017 (KR) 10-2017-0183024
Dec. 28, 2018 (KR) 10-2018-0171710

(51) Int. Cl. F24H 1/08; C02F 1/467; F24D 13/04

(52) U.S. Cl. CPC F24H 1/08; F24H 9/02; F24D 13/04; C02F 1/467

(57) ABSTRACT

A hot water mat according to the present invention comprises: a boiler part including a tank in which water is stored and a heater for heating the water; a mat part including a flow channel for circulating the water supplied from the tank; and a sterilization part for generating a sterilizing material from the water in order to kill germs contained in the water.

### TECHNICAL FIELD

The present disclosure relates to a hot-water mat and a sterilization module used in the hot-water mat.

### BACKGROUND ART

A hot-water mat refers to a heating mat that performs heating by circulating hot water, which is heated to a set temperature in a boiler, along a flow passage provided in a mat. However, the hot-water mat in the related art has a problem in that foreign matter such as germs is generated in the circulating water. Also, the hot-water mat has problems in that the foreign matter is visible to a user's eyes to cause an unpleasant feeling, or forms a bio-film inside the hot-water mat in the circulation process of the water to cause an obnoxious odor.

However, the hot-water mat in the related art does not have a function for removing the foreign matter such as germs. So as to remove the foreign matter, the hot-water mat has to use a chemical or has to have a foreign matter removal member installed in the hot-water mat. However, the chemical has a risk of having an adverse influence on a human body, and the foreign matter removal member needs to be continually replaced because foreign matter continues to be accumulated in the foreign matter removal member.

### Technical Problem

An aspect of the present disclosure provides a hot-water mat for controlling occurrence of foreign matter in advance by simply and safely destroying germs in circulating water.

### Technical Solution

In an embodiment, a hot-water mat includes a boiler including a tank having water stored therein and a heater that heats the water, a mat containing a flow passage through which the water supplied from the tank circulates, and a sterilizer that generates a germicidal material from the water to destroy germs contained in the water.

In another embodiment, a hot-water mat includes a temperature adjustment device including a tank having water stored therein and at least one of a heating device that heats the water and a cooling device that cools the water, a mat containing a flow passage through which the water supplied from the tank circulates, and a sterilizer that generates a germicidal material from the water to destroy germs contained in the water.

In another embodiment, provided is a sterilization module coupled to a hot-water mat including a boiler and a mat, in which the boiler includes a tank having water stored therein and a heater that heats the water and the mat contains a flow passage through which the water supplied from the tank circulates. The sterilization module includes a main body that is disposed between the boiler and the mat and is coupled to the boiler and the mat so as to be removable and that provides a space in which the water flows or is stored when the water circulates between the boiler and the mat, and a sterilization terminal that is provided inside the main body and that generates a germicidal material from the water to destroy germs contained in the water.

### Advantageous Effects

According to the present disclosure, the sterilizer may generate a germicidal material from water to destroy germs contained in the water, thereby very simply and safely removing the germs in the water.

### DESCRIPTION OF DRAWINGS

FIG. 1 is a perspective view illustrating a hot-water mat according to an embodiment of the present disclosure.

FIG. 2 is a schematic view illustrating the hot-water mat according to the embodiment of the present disclosure.

FIG. 3 is a perspective view illustrating a boiler of the hot-water mat according to the embodiment of the present disclosure.

FIG. 4 is an exploded perspective view illustrating the boiler of the hot-water mat according to the embodiment of the present disclosure.

FIG. 5 is a vertical sectional view of the boiler of the hot-water mat according to the embodiment of the present disclosure.

FIG. 6 is a perspective view illustrating the inside of a tank of the hot-water mat according to the embodiment of the present disclosure.

FIG. 7 is a schematic view illustrating a hot-water mat according to another embodiment of the present disclosure.

FIG. 8 is a schematic view illustrating a hot-water mat according to a further embodiment of the present disclosure.

FIG. 9 is a perspective view illustrating the hot-water mat according to the further embodiment of the present disclosure.

### MODE FOR INVENTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

Structure of Hot-Water Mat

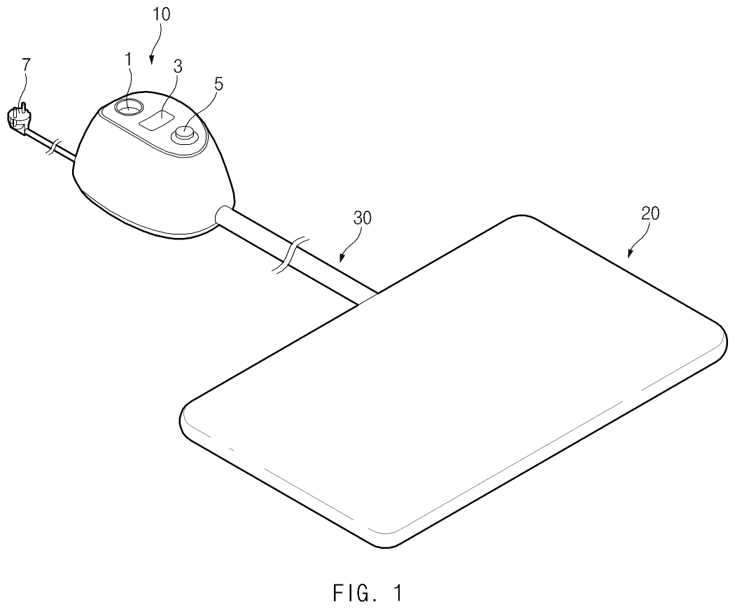

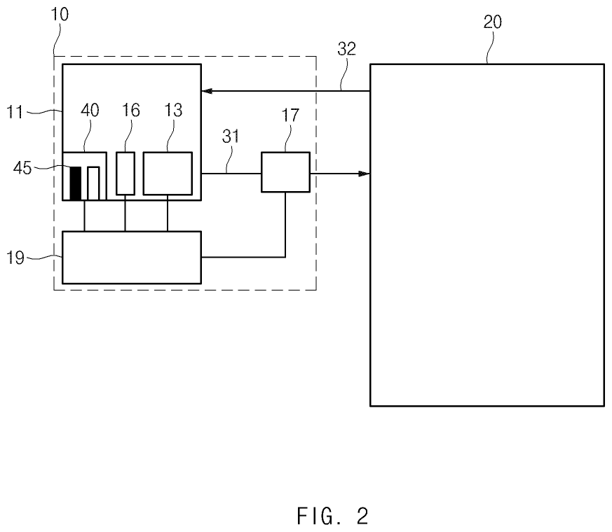

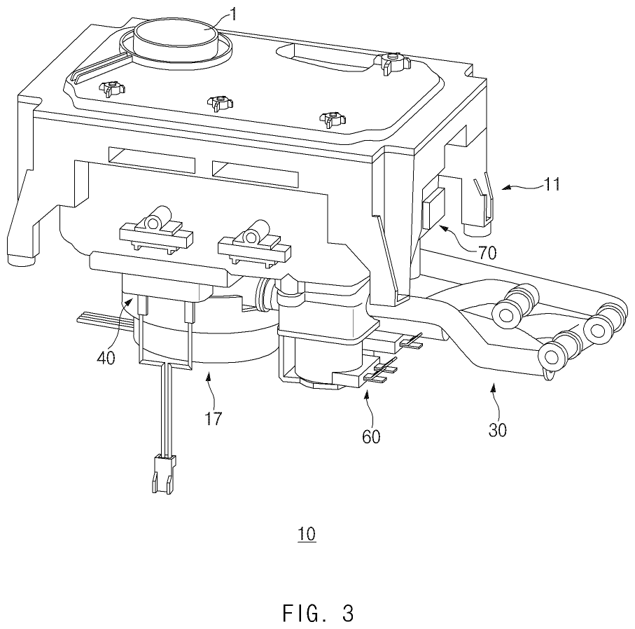

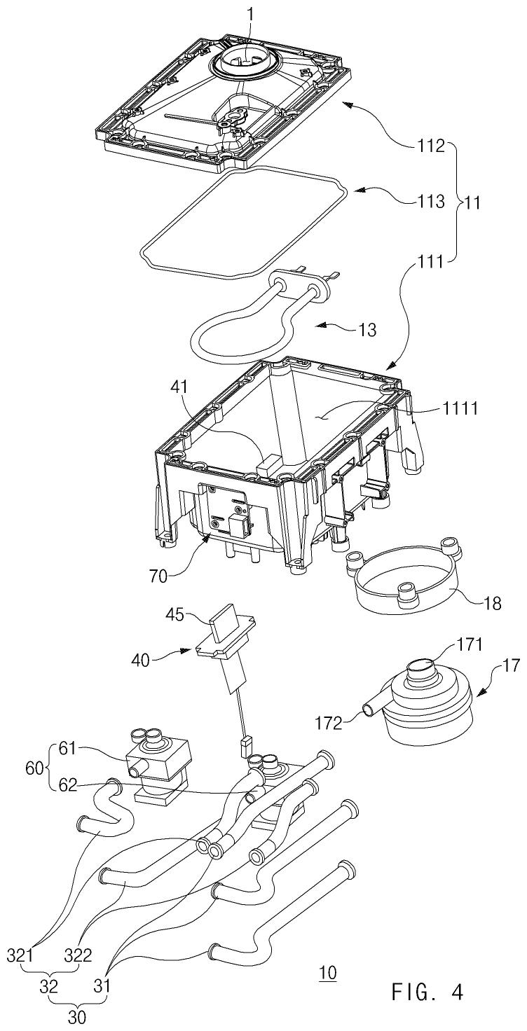

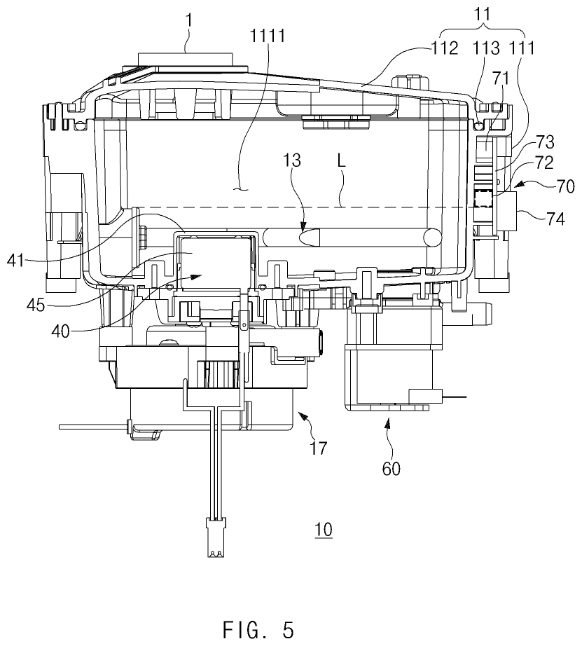

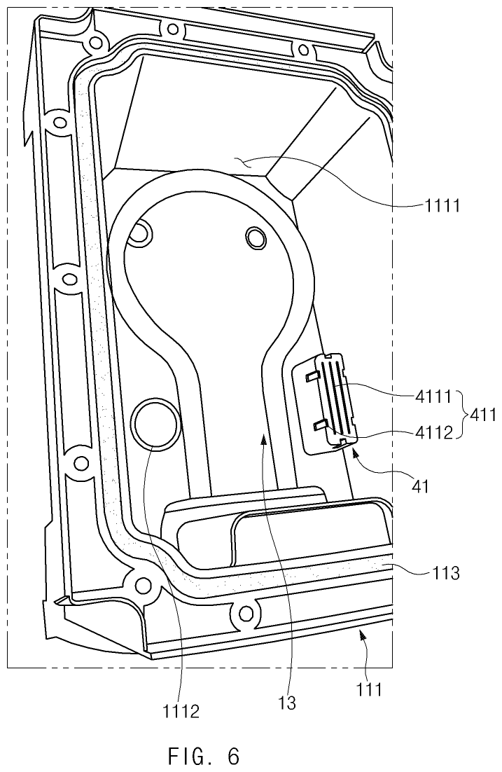

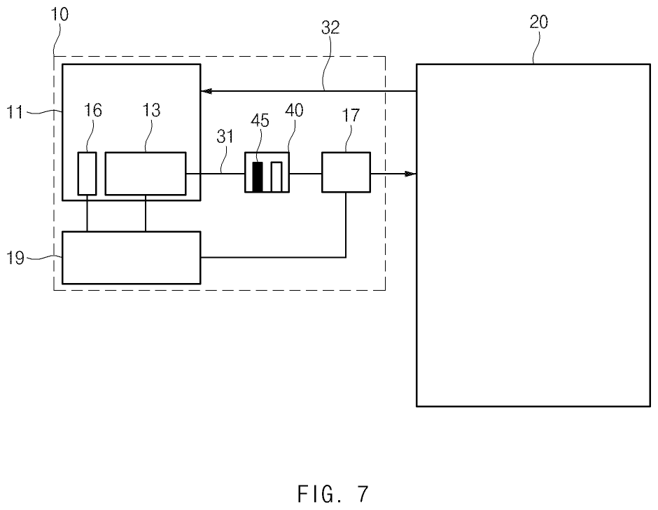

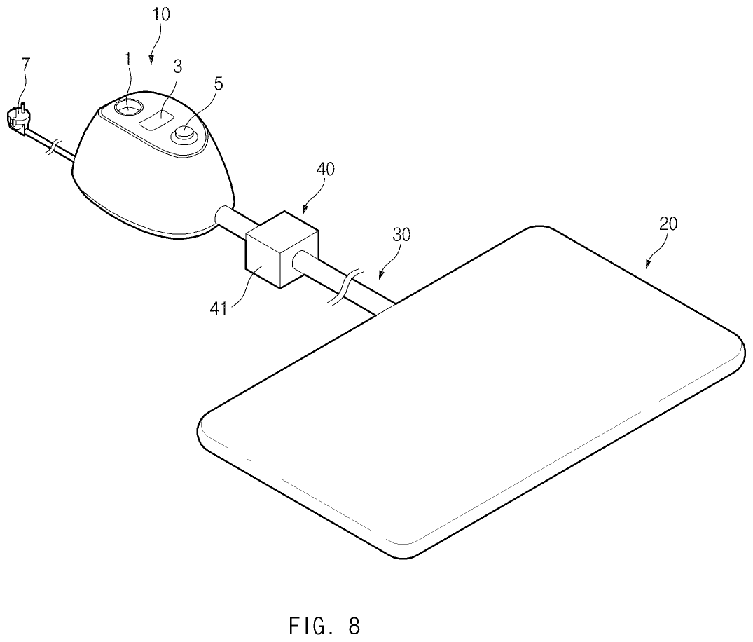

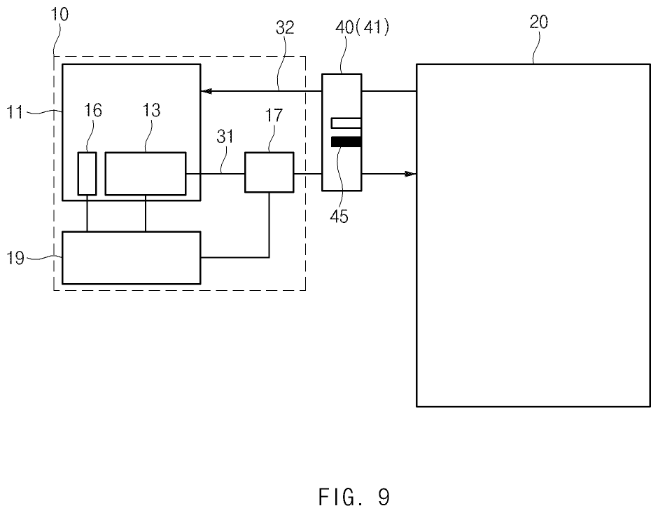

FIG. 1 is a perspective view illustrating a hot-water mat according to an embodiment of the present disclosure. FIG. 2 is a schematic view illustrating the hot-water mat according to the embodiment of the present disclosure. FIG. 3 is a perspective view illustrating a boiler of the hot-water mat according to the embodiment of the present disclosure. FIG. 4 is an exploded perspective view illustrating the boiler of the hot-water mat according to the embodiment of the present disclosure. FIG. 5 is a vertical sectional view of the boiler of the hot-water mat according to the embodiment of the present disclosure. FIG. 6 is a perspective view illustrating the inside of a tank of the hot-water mat according to the embodiment of the present disclosure. FIG. 7 is a schematic view illustrating a hot-water mat according to another embodiment of the present disclosure. FIG. 8 is a perspective view illustrating a hot-water mat according to a further embodiment of the present disclosure. FIG. 9 is a schematic view illustrating the hot-water mat according to the further embodiment of the present disclosure. Hereinafter, the hot-water mats of the present disclosure will be described with reference to FIGS. 1 to 9.

Referring to FIGS. 1 to 6, the hot-water mat according to the embodiment of the present disclosure includes the boiler 10, a mat 20, a connecting part 30, and a sterilizer 40.

First, the boiler 10 may include the tank 11 having water stored therein, a heater 13 for heating the water, a temperature sensor 16 for measuring the temperature of the water, a pump 17 for circulating the water by forcibly feeding the water from the tank 11 into the mat 20 (a flow passage to be described below), and a controller 19 for performing various controls.

The tank 11 may include a tank body 111 having an interior space 1111 in which the water is received and a tank cover 112 for covering an open top side of the tank body. The tank 11 may further include an annular packing 113 to maintain water tightness of a clearance generated when the tank cover 112 and the tank body 111 are coupled.

The tank body 111 may have a drain hole 1112 through which the water is drained. The drain hole 1112 is connected with a pump inlet 171 of the pump 17 connected with a supply pipe 31 and serves as a passage for forcibly feeding the water received in the interior space 1111 of the tank body 111 into the supply pipe 31 through the pump 17.

Furthermore, the boiler 10 may be equipped with an intake 1 formed in the tank cover 112 to supply the water into the tank 11, a display 3 for displaying a control state of the hot-water mat, an adjustment means 5 for adjusting a control state of the hot-water mat, and a cord 7 for connecting the controller 19 with a power supply. A user may set a desired control state by operating the adjustment means 5 after supplying the water into the tank 11 through the intake 1.

The mat 20 may contain the flow passage (not illustrated) for circulating the water supplied from the tank 11. The water stored in the tank 11 may be forcibly fed into the flow passage by the pump 17, and the forcibly fed water may be collected into the tank 11 again after circulating along the flow passage. At this time, the heater 13 may adjust the temperature of the water by heating the water stored in the tank 11 or the circulating water.

The heater 13, which is a component for heating the water received in the tank 11, may be a sheath heater. Accordingly, the heater 13 may be formed in a form in which a metal pipe surrounds a heating wire that generates heat when electric current flows through the heating wire. Electrical insulation powder may fill the space between the pipe and the heating wire at high density. However, the heater 13 may be a heater of a different type rather than the sheath heater. When electric current flows through the heater 13 and the heater 13 radiates heat by the flowing electric current, the radiated heat is transferred to the water around the heater 13 to heat the water. Accordingly, the controller 19 electrically connected to the heater 13 may control operation of the heater by adjusting the electric current flowing through the heater 13.

The connecting part 30 for connecting the boiler 10 and the mat 20 may have, for example, a shape like a tube. The connecting part 30 may be coupled to the boiler 10 and the mat 20 so as to be removable, and the water may circulate between the boiler 10 and the mat 20 through the connecting part 30.

More specifically, the hot-water mat according to the embodiment of the present disclosure may further include the supply pipe 31 and a recovery pipe 32 that are provided inside the connecting part 30. The supply pipe 31 is a pipe for supplying the water stored in the tank 11 into the flow passage, and the recovery pipe 32 is a pipe for collecting the water from the flow passage into the tank 11. That is, the water stored in the tank 11 may be forcibly fed into the flow passage through the supply pipe 31 by the pump 17, may be circulated along the flow passage, and may be collected into the tank 11 through the recovery pipe 32.

The recovery pipe 32 may include a first recovery pipe 321 and a second recovery pipe 322. The first recovery pipe 321 and the second recovery pipe 322 may be connected with the tank 11 and may collect the water from the flow passage of the mat 20. However, the number of pipes constituting the recovery pipe 32 is not limited thereto, and various modifications can be made.

The first recovery pipe 321 and the second recovery pipe 322 may be connected with the tank 11 through a first valve 61 and a second valve 62, respectively. The first valve 61 and the second valve 62 may be implemented with a solenoid valve and may be controlled to be opened or closed by the controller 19 electrically connected thereto. Accordingly, each valve 60 may be closed to block the flow of the water that is collected into the tank 11 through the recovery pipe 32, or may be opened to enable the water to flow. For example, when the temperature of the flow passage to which the recovery pipe 32 is connected reaches a predetermined target temperature, the controller 19 may perform control such that the valve 50 is closed. In another example, when the hot-water mat is powered off, the valve 60 may be closed to block the flow of the water.

The pump 17 may be provided below the tank 11 as illustrated. However, the position of the pump 17 is not specially limited. Instead of the pump 17, a natural circulation method of circulating hot water using vapor pressure may be used to circulate the water. The pump 17 may forcibly feed the water using a centrifugal force of a rotor, such as an impeller, which rotates inside the pump 17. The water is introduced into the pump 17 through the pump inlet 171 connected to the drain hole 1112 of the tank 11, and the pump 17 applies pressure to the introduced water to release the water through a pump outlet 172 connected to the supply pipe 31.

In the water circulation process, germs may multiply. When appropriate temperature and nutrients are given, more germs may multiply, and when multiplication and extinction of germs are repeated in the tank and on the surface of the flow passage or a part, a pollutant called a bio-film is generated. The pollutant may fall off the surface and may be visible to the user's eyes to cause an unpleasant feeling. In addition, the pollutant may cause an obnoxious odor.

The sterilizer 40 for destroying germs contained in the water generates a germicidal material from the water. That is, because the sterilizer 40 can generate the germicidal material from the water without separately injecting a chemical material for sterilization, the germicidal material is environmentally friendly and is not harmful to a human body and may simply or economically remove germs.

More specifically, to generate the germicidal material, the sterilizer 40 may oxidize chlorine ions (Cl−) in the water to chlorine (Cl2). When the chlorine ions (Cl−) are oxidized to the chlorine (Cl2), the chlorine (Cl2) may be immediately melted in the water and may be converted to hypochlorous acid (HOCl). The hypochlorous acid (HOCl) is a germicidal material capable of destroying germs.

To generate the hypochlorous acid (HOCl) as described above, the sterilizer 40 may include a sterilization terminal 45 for oxidizing the chlorine ions (Cl−) to the chlorine (Cl2). When power is supplied to the sterilization terminal 45, the sterilization terminal 45 may oxidize the chlorine ions (Cl−) in the water to the chlorine (Cl2). Further, an outer surface of the sterilization terminal 45 may be coated with platinum group metal oxide (not illustrated) that acts as a catalyst when the chlorine ions (Cl−) are oxidized to the chlorine (Cl2). The platinum group metal oxide may serve as a catalyst by lowering a potential difference when the chlorine ions (Cl−) are oxidized to the chlorine (Cl2).

The platinum group metal oxide may be generated by coating the sterilization terminal 45 with platinum group metal and thereafter oxidizing the platinum group metal by heating the sterilization terminal 45 at high temperature, and for example, platinum, iridium, ruthenium, or the like may be used as the platinum group metal.

Meanwhile, the sterilizer 40 may include a cage 41, and the sterilization terminal 45 may be provided inside the cage 41. The cage 41 may provide a space in which the water flows or is stored when the water circulates between the boiler 10 and the mat 20. As illustrated in FIG. 2, the sterilizer 40 may be provided inside the tank 11. Specifically, as illustrated in FIG. 6, the sterilizer 40 may be disposed as far as possible from the heater 13 in the interior space 1111. The arrangement may prevent a situation in which a sterilization effect is degraded by a large amount of heat. Furthermore, the sterilizer 40 may be disposed below a minimum water level L with respect to a vertical direction. Here, the minimum water level L is a water level that is the basis of a determination as to whether to add water, among water levels of the water received in the tank 11. The amount of the water may be maintained by adding water such that the water received in the tank 11 always has a water level higher than the minimum water level L, and the sterilizer 40 may be located below the minimum water level L. Accordingly, the sterilizer 40 may always be submerged in the water.

The controller 19 may control the sterilizer 40 such that the sterilizer 40 does not operate while the pump 17 operates. That is, because the water circulates while the pump 17 operates, efficiency may be deteriorated when the germicidal material is generated by the sterilizer 40. Accordingly, it may be preferable that when the pump 17 does not operate, that is, when the water substantially stagnates, the sterilizer 40 provided inside the pump 17 generate the germicidal material and the water containing the generated germicidal material be circulated by the pump 17.

In the case of circulating the water after generating the germicidal material when the water stagnates, a germicidal material having a relatively high density may be generated. Accordingly, the number of sterilization operations required for the same sterilization performance or required time may be reduced, and thus the sterilizer 40 may be efficiently operated.

Alternatively, as illustrated in FIG. 7, the pump 17 may be provided on the supply pipe 31, and the sterilizer 40 may be provided in the supply pipe 31 in front of the pump 17. In another case, the sterilizer 40 may be provided in at least one of the tank 11, the supply pipe 31 in front of the pump 17, and the recovery pipe 32. That is, the number of sterilizers 40 is not specially limited. However, for generation of a germicidal material, the sterilizer 40 may preferably be provided in at least one of the tank 11, the supply pipe 31 in front of the pump 17, and the recovery pipe 32 where the pressure of the water is relatively low even though the pump 17 operates.

In another case, as illustrated in FIGS. 8 and 9, the sterilizer 40 may be provided in a modular form and may be disposed between the boiler 10 and the mat 20, in which the sterilizer 40 may be coupled to the boiler 10 and the mat 20 so as to be removable. The sterilizer 40, when disposed inside or outside the boiler 10, may be disposed in the supply pipe 31 or the recovery pipe 32.

More specifically, the sterilizer 40 may include the cage 41, and the sterilization terminal 45 may be provided inside the cage 41. The cage 41 may provide a space in which the water flows or is stored when the water circulates between the boiler 10 and the mat 20. The sterilization terminal 45 may generate the germicidal material from the water to destroy germs contained in the water. The principle of operation of the sterilization terminal 45 is the same as that described above. Therefore, specific description thereabout will be omitted.

When the sterilizer 40 is implemented with a sterilization module as described above, the sterilizer 40 may be selectively coupled to a hot-water mat having no sterilizer embedded therein and may destroy germs in circulating water, and a generated germicidal material, while circulating through the boiler 10 and the mat 20, may destroy germs already generated in the boiler 10 and the mat 20 and remaining therein.

The cage 41 included in the sterilizer 40 may have a slit 411 formed therein for allowing the water stored in the tank 11 to enter or exit the cage 41 and blocking entrance or exit of a scale having a predetermined size or more that is formed in the sterilization terminal 45. A plurality of slits 411 may be formed and may include an upper surface slit 4111 and a side surface slit 4112. The upper surface slit 4111 is a slit formed on an upper surface located at the top of the cage 411, and the side surface slit 4112 is a slit that is formed on a side surface other than the upper surface of the cage 41 and that extends along the vertical direction.

As the slits 411 are formed on the cage 41, a scale generated as an ionic material precipitates in an empty space generated by a bubble when the germicidal material is generated in the sterilizer 40 may be prevented from escaping out of the cage 41. When the scale blocks the drain hole 1112 extending to the pump inlet 171 of the pump 17, the efficiency of the hot-water mat may be deteriorated, and the hot-water mat may fail. Therefore, the sterilization terminal 45 is surrounded by the cage 41 to prevent outflow of the scale.

The hot-water mat according to the embodiment of the present disclosure may further include a water level acquisition device 70. The water level acquisition device 70 is a component for obtaining the water level of the water received in the tank 11. The water level acquisition device 70 may be electrically connected with the controller 19 and may allow the controller 19 to control the sterilizer 40, based on the water level obtained by the water level acquisition device 70. The controller 19 may additionally control the pump 17 and the heater 13, based on the obtained water level.

The water level acquisition device 70 may include a low water level sensor 72 and a high water level sensor 71 as water level sensors and may further include a water level substrate 73.

The low water level sensor 72 and the high water level sensor 71 are components used to obtain a measurement value by measuring the water level of the water received in the tank 11. The water level sensors 71 and 72 may be implemented with a static electricity detection pad of a capacitive type that measures capacitance in a placed state. The capacitances when the water makes contact with the water level sensors 71 and 72 differ from the capacitances when no water makes contact with the water level sensors 71 and 72. The controller 19 may receive the capacitances measured by the water level sensors 71 and 72 and may judge an approximate water level by determining whether the water reaches the corresponding water level sensors 71 and 72.

The high water level sensor 71 and the low water level sensor 72 are located at different heights along the vertical direction. In a case where a measurement value of the low water level sensor 72 corresponds to the measurement value when the water makes contact with the low water level sensor 72 and a measurement value of the high water level sensor 71 does not correspond to the measurement value when the water makes contact with the high water level sensor 72, it can be seen that the water level of the tank 11 at present is equal to or higher than the height of the low water level sensor 71 and is lower than the height of the high water level sensor 71. If measurement values of the two water level sensors 71 and 72 correspond to the measurement values when no water makes contact with the water level sensors 71 and 72, it can be seen that the water level of the tank 11 is lower than the height of the low water level sensor 72. In contrast, if measurement values of the two water level sensors 71 and 72 correspond to the measurement values when the water makes contact with the water level sensors 71 and 72, it can be seen that the water level of the tank 11 is equal to or higher than the height of the high water level sensor 71.

The height of the low water level sensor 72 may be equal to or higher than the minimum water level L. Accordingly, when the water is received in the tank 11 to a degree to which a water level lower than the minimum water level L is satisfied, the controller 19 may recognize that the received water does not satisfy the minimum water level L, from the measurement value of the low water level sensor 72. The height of the high water level sensor 71 may be a height close to an upper end of the tank body 111.

The controller 19 may obtain the water level of the water received in the tank 11, based on measurement values obtained by the water level sensors 71 and 72 and may control the sterilizer 40, based on the obtained water level. To allow the controller 19 to receive the obtained measurement values from the water level sensors 71 and 72, the water level sensors 71 and 72 are electrically connected to the water level substrate 73 implemented with a printed circuit board (PCB), and the water level substrate 73 is electrically connected to the controller 19 through wiring.

In the embodiment of the present disclosure, it has been exemplified that the heater 13, which is a heating device for heating the water, is provided inside the tank 11. However, in a modified example, the hot-water mat may include a cooling device (not illustrated) that cools the water, or the hot-water mat may include at least one of a heating device and a cooling device. Accordingly, in the modified example, at least one of the heating device and the cooling device may be included in a temperature adjustment device together with the tank 11, and the hot-water mat including the temperature adjustment device in addition to the mat 20 and the sterilizer 40 may be provided.

Hot-Water Mat Control Method

Hereinafter, a hot-water mat control method according to an embodiment of the present disclosure will be described. The hot-water mat control method, which will be described below, may be applied to the hot-water mats according to the above-described embodiments.

First, power needs to be supplied for the use of the hot-water mat. Accordingly, as illustrated in FIGS. 1 and 8, the user may connect the controller 19 to the power supply through the cord 7. Thereafter, when a power button is selected by the user, the sterilizer 40, the pump 17, and the heater 13 start to operate depending on a predetermined pattern.

First Operating Pattern

A germicidal material, if generated once, may remain in water for a predetermined period of time. Therefore, the germicidal material may not need to be continually generated. Accordingly, the controller 19 may control the sterilizer 40 such that the sterilizer 40 operates for a predetermined period of time to generate a germicidal material and stops operating for a predetermined period of time.

That is, after the sterilizer 40 operates first depending on input of power, the sterilizer 40 may stop operating, and the pump 17 and the heater 13 may operate. Thereafter, when a predetermined period of time elapses, the sterilizer 40 may operate again to generate a germicidal material. The operating pattern of the sterilizer 40 in the state in which the power is input is referred to as the first operating pattern. The first operating pattern may be stored in a memory included in the controller 19 and may be programmed such that operating time during which the sterilizer 40 operates and stop time during which the sterilizer 40 is stopped are alternately repeated.

Initial Operation

When the controller 19 is connected to the power supply, the user may operate the hot-water mat through the power button (not illustrated) that is provided in the boiler 10 for the use of the hot-water mat.

When the controller 19 is connected to the power supply and the power button is selected by the user, the controller 19 may perform control such that the sterilizer 40 operates first. In other words, when the power button is selected by the user, the sterilizer 40 may immediately operate to perform sterilization first before the pump 17 and the heater 13 operate.

When the pump 17 operates and water circulates, a large amount of germicidal material may not be easy to generate, and even when the heater 13 operates and the temperature of the water exceeds a predetermined temperature, a germicidal material may not be easy to generate. Accordingly, when the user pushes the power button to operate the hot-water mat, the sterilizer 40 may preferably immediately operate to perform sterilization first. When the sterilizer 40 operates and a germicidal material is sufficiently generated, the pump 17 and the heater 13 may operate to circulate and heat the water.

However, when the controller 19 is connected to the power supply and the power button to allow the hot-water mat to operate is selected, the controller 19 may perform control such that the pump 17 as well as the sterilizer 40 operates together. At this time, the controller 19 may additionally perform control such that the heater 13 operates after a predetermined period of time. When operation starts, the controller 19 may operate the pump 17 to circulate the water through the flow passage to cause air left in the flow passage to escape through an air vent formed in the flow passage.

That is, the controller 19 may control the pump 17 and the sterilizer 40 to relatively frequently generate and circulate a relatively low density germicidal material instead of intermittently generating a high density germicidal material or to always perform sterilization and an antibacterial function while the power button is selected. Even though the user stops using the hot-water mat, the water in the flow passage is always in a sterilized state until the user releases the selection of the power button to stop the sterilizer 40, and therefore the antibacterial function may be maintained as long as possible even while the hot-water mat is not used.

As described above, the heater 13 may start to operate after the predetermined period of time. The sterilizer 40 may repeatedly operate and stop after the power button is selected and another predetermined period of time elapses. Here, the predetermined period of time after which the heater 13 starts to operate and the predetermined period of time after which the sterilizer 40 starts to repeatedly operate and stop may be the same period of time, and the period of time may be three minutes, but is not limited thereto.

Operation When Adding Water

The controller 19 may perform control such that the sterilizer 40 operates when water is added into the tank 11. The controller 19 may determine a change in the water level of the water received in the tank 11 by using the water level acquisition device 70. Accordingly, when it is determined that the water level obtained from the water level acquisition device 70 rises and the water is added, the controller 19 may operate the sterilizer 40 for a predetermined period of time. At this time, the predetermined period of time during which the sterilizer 40 operates may be three minutes, but is not limited thereto.

When the sterilizer 40 operates depending on the addition of the water, the pump 17 and the heater 13 may continue to operate, but may stop. Accordingly, while the sterilizer 40 generates a germicidal material, the heater 13 and the pump 17 may stop, and after the sterilizer 40 stops, the heater 13 and the pump 17 may return to the previous operating state. If the pump 17 or the heater 13 is in a stopped state before the addition of the water, when the sterilizer 40 stops after operating depending on the addition of the water, the pump 17 or the heater 13 may operate for a predetermined period of time and may stop again.

In the case of using the low water level sensor 72 and the high water level sensor 71 as the water level acquisition device 70, when a measurement value of the low water level sensor 72 shows that the water does not exist at the water level corresponding to the low water level sensor 72, the controller 19 may inform the user that water needs to be added, by using a notification device (not illustrated) that is additionally electrically connected to the controller 19, or the display 3. As the user opens the intake 1 and pours water into the tank 11, a measurement value of the low water level sensor 72 may be the measurement value when the water makes contact with the low water level sensor 72. When this condition is satisfied, the controller 19 may release the display and the notification by using the notification device or the display 3. Furthermore, as the water is added, the controller 19 may control the sterilizer 40 as described above to generate a germicidal material.

The same control may occur even when a measurement value of the high water level sensor 71 is changed. In a case where a sensor capable of numerically measuring a water level change using an optical method is used as the water level acquisition device 70, the controller 19 may perform control such that the sterilizer 40 operates only when a predetermined amount of water or more is added to raise the water level to a predetermined water level or more.

When water is supplied into the hot-water mat for the first time, sterilization may be performed. When a full water level is obtained by the high water level sensor 71, sterilization may start and may be performed for a predetermined period of time. This is control for sterilization in an initial state and may raise efficiency of a sterilization operation that will be performed later.

When a low water level is obtained by the low water level sensor 72 and thereafter the acquisition of the low water level is released, sterilization may start and may be performed for a predetermined period of time. Accordingly, when water is added anew, the state of the added water may be made into a sterilized state, and therefore an effect of improving efficiency of a next sterilization operation and relatively increasing antibacterial holding time may be obtained.

Manual Sterilization

The controller 19 may control the sterilizer 40 such that the sterilizer 40 operates when a command to operate the sterilizer 40 is input. That is, the controller 19 may perform control such that even though the sterilizer 40 operates depending on a predetermined pattern, when the user manually inputs a sterilization operation, the sterilizer 40 immediately operates to generate a germicidal material.

Changing Supplied Power Depending on Water Quality

Meanwhile, the amount of a germicidal material generated by the sterilization terminal 45 may be adjusted by controlling the magnitude of power to be supplied to the sterilization terminal 45. That is, the controller 19 may control the magnitude of the power to be supplied to the sterilization module 45. The more the supplied power, the more the amount of chlorine (Cl2) to which chlorine ions (Cl−) are oxidized. Accordingly, the amount of hypochlorous acid (HOCl) that the chlorine (Cl2) is melted in the water to generate may be increased.

Further, the magnitude of the power to be supplied to the sterilization terminal 45 to generate a germicidal material may also be determined by the amount of the water, the TDS of the water, the contact area between the sterilization module 45 and the water, and the like.

More specifically, when there is a large amount of water, the volume of an area on which a germicidal material has to act may be large, and therefore a large amount of germicidal material may be required. Accordingly, when the amount of water increases, the magnitude of the power to be supplied to the sterilization module 45 may also increase.

Furthermore, when the TDS of the water is high, a sufficient amount of germicidal material may be generated even though the magnitude of the power to be supplied to the sterilization terminal 45 is decreased. When the TDS of water is low, it may be preferable to induce chlorine ions (Cl−) to sufficiently react by increasing the magnitude of the power to be supplied to the sterilization module 45.

At this time, a reference TDS may be set to determine the degree to which the TDS of the water is low or high, and the reference TDS may be experimentally selected and may be set in the controller 19. That is, the controller 19 may decrease the magnitude of the power to be supplied to the sterilization terminal 45 when the TDS of the water is higher than the reference TDS, and the controller 119 may increase the magnitude of the power to be supplied to the sterilization terminal 45 when the TDS of the water is lower than the reference TDS.

Furthermore, when the contact area between the sterilization module 45 and the water is wide, the controller 119 may decrease the magnitude of the power to be supplied to the sterilization module 145. In contrast, when the contact area between the sterilization module 45 and the water is narrow, the controller 119 may preferably improve reaction strength by increasing the magnitude of the power to be supplied to the sterilization terminal 45.

Control of Operating Time and Stop Time

Stop time of the sterilizer 40 and operating time during which power is supplied to the sterilization terminal 45 to operate the sterilizer 40 may be determined based on at least one of the amount of the water, the total dissolved solid (TDS) of the water, and the contact area between the sterilization module 45 and the water.

More specifically, when there is a large amount of water, the volume of an area on which a germicidal material has to act may be large, and therefore a large amount of germicidal material may be required. Accordingly, when the amount of water is increased, the operating time during which the sterilizer 40 operates may be increased, but the stop time may be decreased.

Furthermore, when the TDS of the water is high, this may mean that the density of ions contained in the water is high, and therefore may mean that the density of chlorine ions (Cl−) in the water is high. That is, when the TDS of the water is high, the density of chlorine ions (Cl−) that react with the sterilization terminal 45 may be high. Accordingly, it may be preferable to decrease the operating time of the sterilizer 40 and increase the stop time.

In contrast, when the TDS of the water is low, it may mean that the density of chlorine ions (Cl−) in the water is low. Therefore, when the TDS of the water is low, the density of chlorine ions (Cl−) that react with the sterilization terminal 45 may be low. Accordingly, to generate a sufficient amount of germicidal material, it may be preferable to increase the operating time of the sterilizer 40 and decrease the stop time.

Furthermore, when the contact area between the sterilization module 45 and the water is wide, the area by which chlorine ions (Cl−) and the sterilization module 45 react with each other may also be wide. Therefore, when the contact area between the sterilization module 45 and the water is wide, a sufficient amount of germicidal material may be generated for a short period of time. Accordingly, it may be preferable to decrease the operating time of the sterilizer 40 and increase the stop time.

Other Controls

The controller 19 may perform control such that while the controller 19 is connected to the power supply and the power button to allow the hot-water mat to operate is selected, the sterilizer 40 operates depending on the first operating pattern and the heater 13 and the pump 17 operate depending on operating conditions thereof irrespective of the operating pattern of the sterilizer 40. That is, the controller 19 may perform control such that the sterilizer 40 operates depending on the first operating pattern and the pump 17 and the heater 13 operate according to conditions thereof irrespective of the operation of the sterilizer.

However, the controller 19, as described above, may control the pump 17 such that the pump 17 stops operating when the sterilizer 40 operates again after stopping operating for a predetermined period of time. That is, to operate the sterilizer 40 in a state in which consistent circulation of the water is stopped, the controller 19 may perform control to stop operation of the pump 17 while the sterilizer 40 operates again, and when the sterilizer 40 stops operating again after a germicidal material is generated by the sterilizer 40 for the operating time, the controller 19 may perform control to operate the pump 17 again.

Specifically, while the controller 19 is connected to the power supply and the power button is selected, the controller 19 may perform operation such that the sterilizer 40 operates at time determined such that the sterilizer 40 operates depending on a predetermined operating pattern and the heater 13 and the pump 17 stop in conjunction with the time when the sterilizer 40 operates depending on the predetermined first operating pattern of the sterilizer 40.

When the sterilizer 40 stops depending on the first operating pattern, the sterilizer 40 may operate depending on the first operating pattern, and the heater 13 and the pump 17 may return to the operating states of the heater 13 and the pump 17 in which the heater 13 and the pump 17 are placed before forcibly stopped. If the heater 13 or the pump 17 in operation is forced to stop due to operation of the sterilizer 40 depending on the first operating pattern, the heater 13 or the pump 17 may start to operate again when the sterilizer 40 stops. If the heater 13 remains in a stop state due to operation of the sterilizer 40 depending on the first operating pattern, the heater 13 may remain stopped without change when the sterilizer 40 stops. However, if the pump 17 remains in a stop state due to operation of the sterilizer 40 depending on the first operating pattern, when the sterilizer 40 stops, the pump 17 may operate for a predetermined period of time and thereafter may stop. To supply a germicidal material generated by operation of the sterilizer 40 into the entirety of the hot-water mat, the pump 17 may temporarily operate before returning to the stop state.

Control Depending on Temperature

The controller 19 may control the sterilizer 40 such that the sterilizer 40 operates only when the temperature of the water is equal to or lower than a predetermined temperature. As described above, when the temperature of the water is too high, a germicidal material may be difficult to generate. Accordingly, the controller 19 may control the sterilizer 40 such that the sterilizer 40 operates only when the temperature of the water is equal to or lower than the predetermined temperature. Here, the predetermined temperature may refer to an experimentally determined temperature.

More specifically, in a case where the temperature of the water exceeds the predetermined temperature, when a command to operate the sterilizer 40 is input to the controller 19, the controller 19 may control the heater 13 to lower the temperature of the water to the predetermined temperature or less and thereafter may perform control such that the sterilizer 40 operates. For example, in a case where the predetermined temperature is set to 60° and the temperature of the water at present exceeds 60°, when a command to operate the sterilizer 40 is input to the controller 19, the controller 19 may lower the temperature of the water to 60° or less by controlling the heater 13 such that the heater 13 does not operate and thereafter may control the sterilizer 40 such that the sterilizer 40 operates.

Alternatively, in a case where a target temperature of the water is set to more than the predetermined temperature when the sterilizer 40 operates, that is, in a case where the user inputs a command to the controller 19 through the adjustment means 5 such that the target temperature of the water exceeds the predetermined temperature, the controller 19 may control the heater 13 to raise the temperature of the water toward the target temperature, and when the temperature of the water exceeds the predetermined temperature, the controller 19 may control the sterilizer 40 such that operation of the sterilizer 40 is stopped.

In a case where the target temperature of the water is set to more than the predetermined temperature when the sterilizer 40 operates, the controller 19 may control the heater 13 to raise the temperature of the water toward the target temperature. In this case, the controller 19 may perform control such that the temperature of the water does not exceed the predetermined temperature during operation of the sterilizer 40 and rises to the target temperature after the sterilizer 40 stops operating.

Second Operating Pattern

When the user pushes the power button to stop operation of the hot-water mat while the hot-water mat operates depending on the above-described control method, the controller 19 may perform control such that the pump 17 and the heater 13 stop operating and the sterilizer 40 operates depending on a predetermined operating pattern. To operate the sterilizer 40, the controller 19 needs to remain connected to the power supply.

More specifically, at the instant when the user pushes the power button to stop operation of the hot-water mat, the controller 19 may perform control such that the sterilizer 40 starts to operate. By generating a germicidal material when the use of the hot-water mat is ended, a sufficient germicidal material may remain in the water even though the sterilizer 40 does not operate before operation of the heater 13 and the pump 17 when the user wants to use the hot-water mat again.

Alternatively, in a case where the controller 19 is connected to the power supply, the controller 19 may control the sterilizer 40 such that even though the hot-water mat stops operating as the user pushes the power button to release the selection of the power button, the sterilizer 40 operates depending on an operating pattern in which operation and stop are repeated at a predetermined time interval. That is, even though the user does not use the hot-water mat, as long as the controller 19 is connected to the power supply through the cord 17, the sterilizer 40 that remains connected with the power supply may generate a germicidal material at a predetermined time interval to maintain a state in which the germicidal material is sufficiently generated.

The operating pattern of the sterilizer 40 in the state in which the hot-water mat stops operating is referred to as the second operating pattern. The second operating pattern may be stored in the memory included in the controller 19 and may be programmed such that operating time during which the sterilizer 40 operates and stop time during which the sterilizer 40 is stopped are alternately repeated.

After the pump 17 stops as the selection of the power button is released, the controller 19 may control the pump 17 such that the pump 17 operates in conjunction with the time when the sterilizer 40 operates depending on the second operating pattern. The controller 19 may control the pump 17 such that the pump 17 operates after a predetermined period of time from the time when the sterilizer 40 operates depending on the second operating pattern. Furthermore, the controller 19 may perform control such that the pump 17 operates in conjunction with the time when the sterilizer 40 stops after operating depending on the second operating pattern. As the pump 17 operates in conjunction with the operation of the sterilizer 40, the generated germicidal material may be supplied in to the hot-water mat.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. A hot-water mat comprising:
a boiler including a tank having water stored therein and a heater configured to heat the water;
a mat containing a flow passage through which the water supplied from the tank circulates; and
a sterilizer configured to generate a germicidal material from the water to destroy germs contained in the water.

2. (canceled)

3. The hot-water mat of claim 1, wherein the sterilizer, including a sterilization terminal coated with platinum group metal oxide acting as a catalyst when chlorine ions (Cl⁻) are oxidized to chlorine (Cl₂), oxidizes the chlorine ions (Cl⁻) in the water to the chlorine (Cl₂) to generate hypochlorous acid (HOCl) as the germicidal material.

4. The hot-water mat of claim 3, further comprising:
a controller configured to control operation of the sterilizer,
wherein the controller adjusts an amount of the germicidal material generated from the water, by controlling a magnitude of power to be supplied to the sterilization terminal, based on at least one of an amount of the water, total dissolved solid (TDS) of the water, and a contact area between the sterilization terminal and the water.

5. (canceled)

6. The hot-water mat of claim 4, wherein in a case of determining the magnitude of the power to be supplied to the sterilization terminal based on the TDS of the water, when the TDS of the water is higher than a reference TDS, the controller decreases the magnitude of the power to be supplied to the sterilization terminal, and when the TDS of the water is lower than the reference TDS, the controller increases the magnitude of the power to be supplied to the sterilization terminal.

7. (canceled)

8. The hot-water mat of claim 1, further comprising:
a supply pipe configured to supply the water stored in the tank into the flow passage, a recovery pipe configured to collect the water from the flow passage into the tank, and a pump provided on the supply pipe and configured to forcibly feed the water from the tank into the flow passage,
wherein the sterilizer is provided in at least one of the tank, the supply pipe in front of the pump, and the recovery pipe.

9. (canceled)

10. The hot-water mat of claim 1, further comprising:
a controller configured to control operation of the sterilizer,
wherein the sterilizer includes a sterilization terminal configured to oxidize chlorine ions (Cl⁻) in the water to chlorine (Cl₂) to generate the germicidal material,
wherein the controller controls the sterilizer such that the sterilizer is repeatedly operated and stopped by supplying or shutting off power to the sterilization terminal, and
wherein stop time during which the sterilizer is stopped and operating time during which power is supplied to the sterilization terminal are determined, based on at least one of an amount of the water, total dissolved solid (TDS) of the water, and a contact area between the sterilization terminal and the water.

11. The hot-water mat of claim 1, further comprising:
a pump configured to forcibly feed the water from the tank into the flow passage to circulate the water and a controller configured to control operation of the pump and the sterilizer,
wherein the controller controls the sterilizer such that the sterilizer does not operate while the pump operates.

12. The hot-water mat of claim 1, further comprising:
a controller configured to control operation of the heater and the sterilizer,
wherein the controller controls the sterilizer such that the sterilizer operates only when temperature of the water is equal to or lower than a predetermined temperature.

13. The hot-water mat of claim 12, wherein when the temperature of the water exceeds the predetermined temperature and a command to operate the sterilizer is input to the controller, the controller controls the heater to lower the temperature of the water to the predetermined temperature or less and thereafter controls the sterilizer such that the sterilizer operates.

14. The hot-water mat of claim 12, wherein when the sterilizer operates and a target temperature of the water is set to more than the predetermined temperature, the controller controls the heater to raise the temperature of the water toward the target temperature and controls the sterilizer such that the sterilizer stops operating when the temperature of the water exceeds the predetermined temperature.

15. (canceled)

16. The hot-water mat of claim 1, further comprising:
a pump configured to forcibly feed the water from the tank into the flow passage to circulate the water and a controller configured to control operation of the pump, the heater, and the sterilizer,
wherein when the controller is connected to a power supply and a power button configured to allow the hot-water mat to operate is selected, the controller performs control such that the sterilizer operates before the pump and the heater operate.

17. The hot-water mat of claim 1, further comprising:
a pump configured to forcibly feed the water from the tank into the flow passage to circulate the water and a controller configured to control operation of the pump, the heater, and the sterilizer,
wherein when the controller is connected to a power supply and a power button configured to allow the hot-water mat to operate is selected, the controller performs control such that the sterilizer and the pump operate and the heater operates after a predetermined period of time.

18. The hot-water mat of claim 1, further comprising:
a pump configured to forcibly feed the water from the tank into the flow passage to circulate the water and a controller configured to control operation of the pump, the heater, and the sterilizer,
wherein when the controller is connected to a power supply and selection of a power button configured to allow the hot-water mat to operate is released, the controller performs control such that the pump and the heater stop operating, but the sterilizer operates depending on a predetermined operating pattern.

19. (canceled)

20. The hot-water mat of claim 18, wherein when the controller is connected to the power supply and the selection of the power button configured to allow the hot-water mat to operate is released, the controller performs control such that the pump stops and thereafter the pump operates in conjunction with time when the sterilizer operates depending on the operating pattern.

21. (canceled)

22. (canceled)

23. The hot-water mat of claim 1, further comprising:
a pump configured to forcibly feed the water from the tank into the flow passage to circulate the water and a controller configured to control operation of the pump, the heater, and the sterilizer,
wherein when the controller is connected to a power supply and selection of a power button configured to allow the hot-water mat to operate is released, the controller performs control such that the heater stops operating, the sterilizer operates at time determined such that the sterilizer operates depending on a predetermined operating pattern, and the pump operates in conjunction with the time when the sterilizer operates depending on the predetermined operating pattern of the sterilizer.

24. The hot-water mat of claim 1, further comprising:
a pump configured to forcibly feed the water from the tank into the flow passage to circulate the water and a controller configured to control operation of the pump, the heater, and the sterilizer,
wherein when the controller is connected to a power supply and a power button configured to allow the hot-water mat to operate is selected, the controller performs control such that while the power button is selected, the sterilizer operates at time determined such that the sterilizer operates depending on a predetermined operating pattern, and the heater and the pump stop in conjunction with the time when the sterilizer operates depending on the predetermined operating pattern of the sterilizer.

25. The hot-water mat of claim 24, wherein when the sterilizer stops after operating depending on the operating pattern, the controller performs control such that right before the heater and the pump stop in conjunction with the time when the sterilizer operates depending on the operating pattern, the heater and the pump return to an operating state in which the heater and the pump are placed.

26. The hot-water mat of claim 1, further comprising:
a pump configured to forcibly feed the water from the tank into the flow passage to circulate the water and a controller configured to control operation of the pump, the heater, and the sterilizer,
wherein when the controller is connected to a power supply and a power button configured to allow the hot-water mat to operate is selected, the controller performs control such that while the power button is selected, the sterilizer operates depending on a predetermined operating pattern and the heater and the pump operate depending on an operating condition of the heater and an operating condition of the pump irrespective of the operating pattern of the sterilizer.

27. The hot-water mat of claim 1, further comprising:
a controller configured to control operation of the sterilizer,
wherein the controller controls the sterilizer such that the sterilizer operates when a command to operate the sterilizer is input.

28. The hot-water mat of claim 1, wherein the sterilizer is received in the tank and is disposed below a minimum water level that is the basis of a determination as to whether to add water, among water levels of the water received in the tank with respect to a vertical direction.

29. The hot-water mat of claim 1, further comprising:
a controller configured to control operation of the sterilizer,
wherein the controller controls the sterilizer such that the sterilizer operates when water is added into the tank.

30. The hot-water mat of claim 29, further comprising:
a pump configured to forcibly feed the water from the tank into the flow passage to circulate the water,
wherein the controller additionally controls operation of the heater and the pump,
wherein when the water is added into the tank, the controller performs control such that the sterilizer operates for a predetermined period of time and the heater and the pump stop, and
wherein the controller performs control such that after the predetermined period of time elapses, the sterilizer stops and the heater and the pump operate for another predetermined period of time.

31. (canceled)

32. The hot-water mat of claim 1, further comprising:
a water level sensor configured to obtain a measurement value by measuring a water level of the water received in the tank; and
a controller configured to obtain the water level of the water received in the tank, based on the measurement value obtained by the water level sensor and control the sterilizer, based on the obtained water level.

33. The hot-water mat of claim 1, wherein the sterilizer includes a sterilization terminal configured to generate the germicidal material and a cage configured to surround the sterilization terminal, and
wherein the cage has a slit formed therein for allowing the water stored in the tank to enter or exit the cage and blocking entrance or exit of a scale having a predetermined size or more that is formed in the sterilization terminal.

34. A hot-water mat comprising:
a temperature adjustment device including a tank having water stored therein and at least one of a heating device configured to heat the water and a cooling device configured to cool the water;
a mat containing a flow passage through which the water supplied from the tank circulates; and
a sterilizer configured to generate a germicidal material from the water to destroy germs contained in the water.

35. (canceled)
